(19) United States
(12) Patent Application Publication
(10) Pub. No.: US 2016/0225253 A1
(43) Pub. Date: Aug. 4, 2016

(54) SYSTEM AND METHOD FOR PROVIDING VEHICLES WITH INFORMATION ABOUT EVENTS OCCURRED ON ROAD

(71) Applicant: UNIVERSITY OF SEOUL INDUSTRY COOPERATION FOUNDATION, Seoul (KR)

(72) Inventor: Jin Suk KIM, Seoul (KR)

(73) Assignee: UNIVERSITY OF SEOUL INDUSTRY COOPERATION FOUNDATION, Seoul (KR)

(21) Appl. No.: 15/093,576

(22) Filed: Apr. 7, 2016

Related U.S. Application Data
(63) Continuation of application No. 13/718,170, filed on Dec. 18, 2012, now abandoned.

(30) Foreign Application Priority Data
Apr. 30, 2012 (KR) 10-2012-0045288

(51) Int. Cl. G08G 1/01; G08G 1/0965; G08G 1/09

(52) U.S. Cl. CPC G08G 1/0112; G08G 1/0116; G08G 1/091; G08G 1/0965

(57) ABSTRACT

The present invention is directed to a system and method for providing vehicles with information about an event occurred on a road, capable of effectively providing information about an accident on a road to vehicles driving toward the region where the accident has occurred, even during hours or in regions in which vehicle traffic is low.

### TECHNICAL FIELD

The described technology relates generally to a system and method for providing vehicles with information about events occurred on a road.

### BACKGROUND

With the advancement of living standards, vehicle penetration rate has rapidly increased. In proportion to the vehicle penetration rate, traffic accidents are also increasing. As the vehicle penetration rate increases and vehicles become an essential part of people's everyday life, people are exposed to a higher risk of traffic accidents. Conventional technologies related to vehicles have been focused on improvement in the performance of vehicles as a means of transportation, however, recently, importance on technologies related to traffic accidents and vehicle safety services has come to the fore since they are associated with human life.

Particularly, in bad weather conditions such as fog or heavy rain that modify the background that can affect driving, the risk of a multi-collision accident is high since drivers have difficulty in recognizing an accident involving preceding vehicles. Studies into technologies for preventing a multi-collision accident in advance by automatically notifying following vehicles wirelessly that a traffic accident occurred, are underway. Such technologies include an audio device control method. However, the audio device control method has difficulties in actual implementation since there is no way to control directly at outside of the vehicle. Also, the radio control method intervenes in the control of important elements of a vehicle, which increases the risk of accidents due to wrong operations. Also, there is a method based on vehicle-to-vehicle (V2V) communication. V2V communication means wireless communication for signal/data transmission and reception between running or stopped vehicles. V2V communication includes, in a wide sense, a method for communication between vehicles through a base station, however, substantially, V2V communication is used to prevent traffic accidents or avoid successive occurrences of accidents. Specifically, V2V communication is applied to warn of a danger/accident ahead, or to warn of an intersection collision.

However, a conventional method for sending information about a traffic accident to following vehicles using V2V communication is disabled when the following vehicles are out of the coverage area. Accordingly, during hours in which vehicle traffic is low such as dawn or at night, or on roads where vehicle traffic is low, it is rather difficult to properly provide information about a traffic accident although a higher risk of accidents exists.

### SUMMARY

The present invention is directed to a system and method for providing vehicles with information about an event occurred on a road, capable of effectively providing information about an accident on a road to vehicles driving toward the region where the accident has occurred, even during hours or in regions in which vehicle traffic is low.

The present invention is also directed to a system and method for providing vehicles with information about an event occurred on a road, capable of preventing an accident in advance by properly detecting various traffic-interfering events occurred on a road.

In one embodiment, there is provided a method of providing vehicles with information about an event occurred on a road, comprising: at a first vehicle running in a first direction on the road, detecting a traffic-interfering event; and at the first vehicle, broadcasting event information including the location at which the event has occurred, or the heading direction of the first vehicle, wherein the broadcasted event information is received by a second vehicle running in a second direction that is a different direction from the first direction on the road, and broadcasted by the second vehicle.

In another embodiment, there is provided a method of providing vehicles with information about an event occurred on a road, comprising: at a second vehicle running in a second direction on the road, receiving event information including the location at which a traffic-interfering event has occurred, or the heading direction of a first vehicle, from the first vehicle running in a first direction that is a different direction from the second direction on the road; and at the second vehicle, broadcasting the received event information during a predetermined time period or during a time period for which the second vehicle runs a predetermined distance.

In another embodiment, there is provided a method of providing vehicles with information about an event occurred on a road, comprising: at a plurality of relays arranged along the road, receiving event information including the location at which a traffic-interfering event has occurred, or the heading direction of a first vehicle from the first vehicle running in a first direction on the road; and at the plurality of relays, broadcasting the received event information, wherein the broadcasted event information is received by a second vehicle running in a second direction that is a different direction from the first direction on the road along which the plurality of relays are arranged, and the event information is broadcasted during a predetermined time period or during a time period for which the second vehicle runs a predetermined distance.

In another embodiment, there is provided a system of providing information about an event occurred on a road, comprising: a first detector configured to detect a traffic-interfering event occurred on a road; a second detector configured to detect the location of the vehicle or the heading direction of the vehicle; a controller configured to create, if the traffic-interfering event is detected by the first detector, first event information about the vehicle based on the results of detections by the first detector and the second detector; and a communication unit configured to broadcast the first event information, or to broadcast or receive second event information including a traffic-interfering event detected by another vehicle and the location or heading direction of the other vehicle, wherein if the first event information is created, the controller controls the communication unit to broadcast the first event information, and if the second event information is received through the communication unit, the controller controls the communication unit to broadcast the second event information during a predetermined time period or during a time period for which the vehicle runs a predetermined distance.

According to the present disclosure, a driver can receive various kinds of information without limitation on direction or distance, even in weather conditions that modify the background that can affect driving. Since vehicles exchange their driving information with other vehicles to notify of any dangerous situations, multi-collision accidents can be prevented.

Also, when a traffic pattern changes, related information is transferred to vehicles through V2V communication so that drivers can promptly cope with the change in traffic pattern. In addition, by supporting a driver's precognition about an accident, accidents themselves can be prevented.

The Summary is provided to introduce a selection of concepts in a simplified form that are further described below in the Detailed Description. The Summary is not intended to identify key features or essential features of the claimed subject matter, nor is it intended to be used as an aid in determining the scope of the claimed subject matter.

### BRIEF DESCRIPTION OF THE DRAWINGS

The above and other features and advantages of the present disclosure will become more apparent to those of ordinary skill in the art by describing in detail example embodiments thereof with reference to the attached drawings in which:

FIG. 1 is a block diagram illustrating a system for providing vehicles with information about an event occurred on a road, according to one embodiment;

FIG. 2 shows an example in which a traffic-interfering event has occurred on a road;

FIGS. 3 and 4 are flowcharts illustrating a method for providing vehicles with information about the event occurred on the road in the example shown in FIG. 2;

FIG. 5 shows another example in which a traffic-interfering event has occurred on a road; and

FIG. 6 is a flowchart illustrating a method for providing vehicles with information about the event occurred on the road in the example shown in FIG. 5.

### DETAILED DESCRIPTION

It will be readily understood that the components of the present disclosure, as generally described and illustrated in the Figures herein, could be arranged and designed in a wide variety of different configurations. Thus, the following more detailed description of the embodiments of apparatus and methods in accordance with the present disclosure, as represented in the Figures, is not intended to limit the scope of the disclosure, as claimed, but is merely representative of certain examples of embodiments in accordance with the disclosure. The presently described embodiments will be best understood by reference to the drawings, wherein like parts are designated by like numerals throughout. Moreover, the drawings are not necessarily to scale, and the size and relative sizes of the layers and regions may have been exaggerated for clarity.

It will also be understood that when an element or layer is referred to as being “on,” another element or layer, the element or layer may be directly on the other element or layer or intervening elements or layers may be present. As used herein, the term “and/or” may include any and all combinations of one or more of the associated listed items.

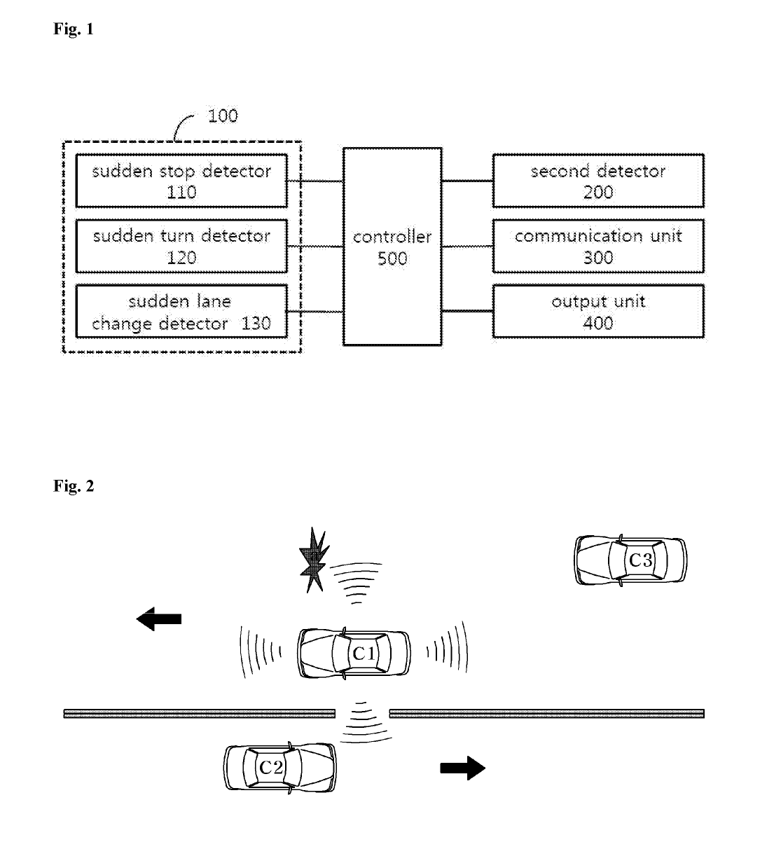

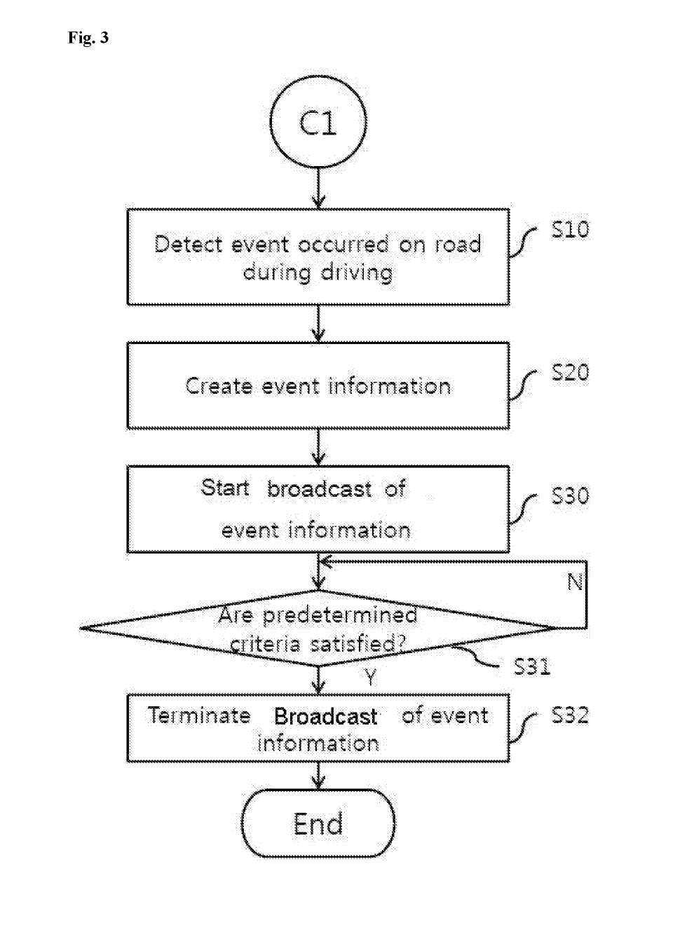

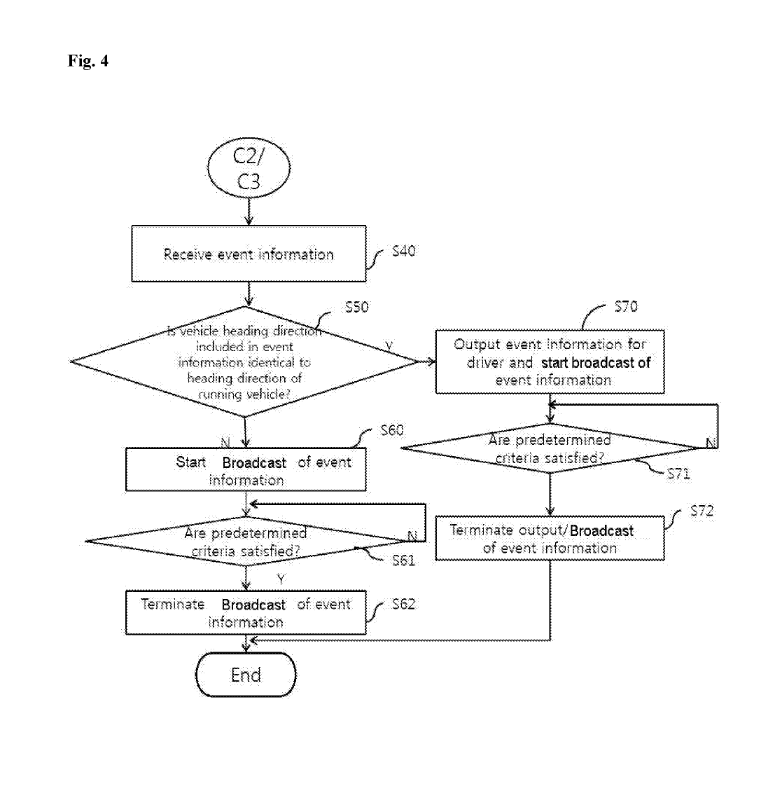

FIG. 1 is a block diagram illustrating a system for providing vehicles with information about an event occurred on a road, according to one embodiment, FIG. 2 shows an example in which a traffic-interfering event has occurred on a road, and FIGS. 3 and 4 are flowcharts illustrating a method for providing vehicles with information about the event occurred on the road in the example shown in FIG. 2.

Referring to FIG. 1, the system for providing vehicles with information about an event occurred on a road includes a first detector 100, a second detector 200, a communication unit 300, an output unit 400, and a controller 500.

The first detector 100 detects a traffic-interfering event when the event has occurred on a road. The first detector 100 may include a sudden turn detector 110, a sudden stop detector 120, and a sudden lane change detector 130. Although not shown in FIG. 1, the first detector 100 may include several event detecting units for detecting various events that can interfere with traffic. The event detecting units may include a slide detector, a rollover detector, a collision detector, an airbag inflation detector, a Klaxon detector, etc.

The sudden turn detector 110 detects a sudden turn of a vehicle. For example, the sudden turn detector 110 may determine that a sudden turn has occurred if a steering wheel's rotation angle exceeds a predetermined angle at above a predetermined speed. For example, the sudden turn detector 110 may detect a sudden turn from a combination of a steering wheel's rotation sensor signal from a sensor installed in a steering wheel to detect the steering wheel's rotation angle, and a vehicle's speed sensor signal from a vehicle speed sensor or a global positioning system (GPS).

The sudden stop detector 120 detects a sudden stop of the vehicle. For example, the sudden stop detector 120 may determine that a sudden stop has occurred if a speed variation exceeds a predetermined threshold value. For example, the sudden stop detector 120 may detect a sudden stop using the changed amounts of speed sensor signals sensed by a vehicle speed sensor or a GPS, etc.

The sudden lane change detector 130 checks whether or not a vehicle changes lanes in a predetermined time period during driving. For example, the sudden lane change detector 130 may detect a sudden lane change of the vehicle from pictures captured by a camera installed in the vehicle to photograph the road. For example, the sudden lane change detector 130 detects lanes from pictures captured by the camera, and determines that a sudden lane change has occurred if the change rate of a reference lane location per hour exceeds a predetermined value. Also, if it is determined that the vehicle crosses a predetermined number or more of lanes from the pictures, the sudden lane change detector 130 may detect a sudden lane change.

The slide detector (not shown) detects a slide of the vehicle during driving. When the vehicle slides, for example, on an icy or wet road, the direction in which the vehicle's wheels head becomes different from the heading direction of the vehicle, and the slide detector detects a slide of the vehicle based on the difference in direction. For example, a slide of the vehicle may be detected by a combination of a wheel direction sensor signal from a sensor installed in a wheel or steering wheel to detect rotation direction of the wheel or steering wheel, and a heading direction signal from a GPS, etc.

The rollover detector (not shown) detects a rollover event of the vehicle during driving. The rollover detector may include an angular rate sensor for sensing attitude rate of change of a vehicle and a lateral accelerometer for sensing lateral dynamic of the vehicle.

The second detector 200 detects the location of the vehicle and the heading direction of the vehicle. The second detector 200 may be implemented as a GPS, a sensor, or a mobile terminal. GPS, which is a satellite navigation system of receiving signals transmitted from a GPS satellite to calculate the current location of a vehicle, provides information about the vehicle, such as current location, heading direction, speed, etc. of the vehicle. The GPS may be installed in the system, or may be a GPS attached to a general navigation system installed in the vehicle.

The communication unit 300 may include a transmitter and a receiver. The communication unit 300 may use Ad Hoc networking, a packet radio network, a local network, dedicated short range communication (DSRC), or a vehicle-to-vehicle (V2V) communication system. DSRC is a system in which road side equipment (RSE) and onboard equipment (OBE) broadcast and receive various kinds of information through near field communication (NFC), and is a core technology of an intelligent transportation system (ITS). V2V communication system is a system which allows direct communication between vehicles not via infrastructure located at roads, intersections, etc. The V2V communication system may use a Wi-Fi network as a wireless communication network, a dedicated channel allocated by NFC, etc.

The output unit 400 is in charge of a user interface. The output unit 400 may output information about the vehicle's heading direction together with location information included in event information, in the form of a voice signal or an image, to a driver. The output unit 400 may include a speaker, a display, a buzzer, a warning lamp, etc.

The controller 500 is connected to the first detector 100, the second detector 200, the communication unit 300, or the output unit 400, wired or wirelessly, receives a detection signal, a sensing signal, a reception signal, etc. from the first detector 100, the second detector 200, the communication unit 300, or the output unit 400, and outputs control signals to the first detector 100, the second detector 200, the communication unit 300, or the output unit 400. For example, if it is determined that an event interfering with a vehicle's driving has occurred from a received signal, the controller 500 may create event information including location and time at which the event occurred, the vehicle's heading direction, or the kind of event.

In the following description, event information of a vehicle is referred as first event information, and event information of another vehicle is referred to as second event information.

The controller 500 may control the communication unit 300 to broadcast the first event information. Also, if the second event information is received, the controller 500 may control the communication unit 300 to broadcast the second event information. Also, the controller 500 determines whether or not another vehicle's heading direction included in the second event information is identical to the vehicle's heading direction. If the heading directions are identical to each other, the controller 500 controls the output unit 400 to output the second event information for the vehicle's driver while the vehicle runs in a predetermined area or until a predetermined time period elapses. If the other vehicle's heading direction is not identical to the vehicle's heading direction, the controller 500 may control the communication unit 300 to only broadcast the second event information without outputting the second event information to the driver.

In other words, when a traffic-interfering event occurs on a road, the system detects the event to create first event information, and broadcasts the first event information to other vehicles that run in the same direction in which a vehicle including the system runs, and in the different directions from which the vehicle runs. Also, if the system receives second event information from another vehicle, the system broadcasts the second event information, and if the other vehicle's heading direction included in the second event information is identical to the vehicle's heading direction, the system may output the second event information to the driver.

Hereinafter, a method of providing vehicles with information about an event occurred on a road using the system of providing vehicles with information about an event occurred on a road as described above will be described with reference to FIGS. 2, 3, and 4.

FIG. 2 shows an example in which first, second, and third vehicles C1, C2, and C3 run on a road, wherein the first and third vehicles C1 and C3 run in a first direction (in a left direction) on the road, and the second vehicle C2 runs in a second direction (in a right direction) on the road. The example of FIG. 2 corresponds to a situation where a traffic-interfering event occurs when the first vehicle C1 runs in the first direction in the same lane in which the third vehicle C3 runs, so that the first vehicle C1 suddenly changes lanes to the left lane, and the second vehicle C2 runs in the second direction while passing through an area where an event occurred.

FIG. 3 is a flowchart illustrating a method in which the first vehicle C1 provides other vehicles with information about a traffic-interfering event occurred on a road, in the situation shown in FIG. 2.

As shown in FIGS. 2 and 3, when the driver of the first vehicle C1 finds a stopped vehicle in the lane or the first vehicle C1 itself has a breakdown or an accident while the first vehicle C1 runs in the first direction on the road, the first vehicle C1 stops, turns, or changes lanes suddenly before reaching the stopped vehicle. In this situation, the first detector (100 of FIG. 1) detects a traffic-interfering event (S10). If the event is detected, the controller (500 of FIG. 1) of the first vehicle C1 generates event information (S20). The event information is broadcasted through the communication unit (300 of FIG. 1). Transmission of the event information by the first vehicle C1 may be terminated once the event information is broadcasted, or when predetermined criteria are satisfied (S31 and S32). The predetermined criteria may be selected as a time period between one minute and several hours according to the kind or location of the event, accident statistics, etc. For example, when 5, 10, or 15 minutes elapse after an event has occurred, transmission of event information may be terminated. Also, the predetermined criteria may be when a vehicle has passed a predetermined distance from the occurred event location. The predetermined distance may be set as a distance between 1 km and several dozens of km according to the kind, location, or time of the occurred event, accident statistics, etc. For example, when the first vehicle C has passed 1 km, 5 km, or 10 km from a location of an occurred event, transmission of event information may be terminated.

FIG. 4 is a flowchart illustrating a method in which the second vehicle C2 or the third vehicle C3 receives information about a traffic-interfering event occurred on a road, outputs the event information for the driver, and provides the event information to other vehicles, in the situation shown in FIG. 2.

Referring to FIGS. 2 and 4, event information broadcasted from the first vehicle C1 can be received by a communication unit of the second vehicle C2 or the third vehicle C3 that passes through a coverage area of a communication unit of the first vehicle C1 (S40). If the communication unit of the second vehicle C2 or the third vehicle C3 receives the event information, it is determined whether or not a vehicle's heading direction included in the event information is identical to the heading direction of the second vehicle C2 or the third vehicle C3 (S50).

If the second vehicle C2 that runs in the reverse direction to that of the first vehicle C1 receives the event information, the second vehicle C2 broadcasts the event information through its communication unit (S60), determines that its heading direction is not identical to the vehicle's heading direction included in the event information, and does not output the event information for the driver. If the third vehicle C3 that runs in the same direction as that of the first vehicle C1 receives the event information (S40), the third vehicle C3 determines that its heading direction is identical to the vehicle's heading direction included in the event information (S50), outputs the event information for the driver through an output unit, such as a speaker, a display, a warning lamp, etc., and also broadcasts the event information through a communication unit (S60). Transmission of the event information by the second vehicle C2 may be terminated once the event information is once broadcasted, or when a predetermined criteria is satisfied (S61 and S62). The predetermined criteria may be when a predetermined time period has elapsed from the time an event occurred, the time at which the first vehicle C1 has broadcasted event information, or the time at which the second vehicle C2 has received event information. The predetermined time period may be selected as a time period between one minute and several hours according to the kind or location of the event, accident statistics, etc. For example, when 5, 10, or 15 minutes have elapsed after an event has occurred, transmission of event information may be terminated. Also, the predetermined criteria may be when the second vehicle C2 has passed a predetermined distance from the location of an occurred event, a location at which the first vehicle C1 has broadcasted event information, or a location at which the second vehicle C2 has received event information. The predetermined distance may be set as a distance between 1 km and several dozens of km according to the kind, location, or time the event occurred, accident statistics, etc. For example, when the second vehicle C2 has passed 1 km, 5 km, or 10 km from a location of an occurred event, transmission of the event information may be terminated.

The third vehicle C3 receives the event information (S40), determines whether or not its heading direction is identical to the vehicle's heading direction included in the event information (S50), and outputs the event information for the driver, through an output unit, such as a speaker, a display, a warning lamp, etc., if its heading direction is identical to the vehicle's heading direction included in the event information (S70). Then, the third vehicle C3 may broadcast the event information (S60).

Broadcasting or output of the event information by the third vehicle C3 may be terminated once the event information is broadcasted/output, or when predetermined criteria are satisfied (S71 and S72). The predetermined criteria may be when a predetermined time period has elapsed from the time an event occurred, the time at which the first vehicle C1 has broadcasted event information, or the time at which the third vehicle C3 has received event information. The predetermined time period may be selected as a time period between one minute and several hours according to the kind or location of the event, accident statistics, etc. For example, when 5, 10, or 15 minutes have elapsed after an event has occurred, transmission of event information may be terminated. Also, the predetermined criteria may be when the third vehicle C3 has passed a predetermined distance from the location of an occurred event, a location at which the first vehicle C1 has broadcasted event information, or a location at which the third vehicle C3 has received event information. The predetermined distance may be set as a distance between 1 km and several dozens of km according to the kind, location, or time the event occurred, accident statistics, etc. For example, when the third vehicle C3 has passed 1 km, 5 km, or 10 km from the location of an occurred event, broadcasting of the event information may be terminated.

The exemplary situation of FIG. 2 is seen as if the third vehicle C3 runs adjacent to the first vehicle C1, however, this is only distortion of scale for representing the first and third vehicles C1 and C3 on the same drawing. There is the case where the third vehicle C3 running in the same direction as that of the first vehicle C1 is a long distance away from the first vehicle C1 and thus deviated from the coverage area of the communication unit of the first vehicle C1. In this case, in conventional technologies, the third vehicle C3 that is to pass through an area at which a traffic-interfering event has occurred may fail to receive the event information. However, according to this disclosure, event information detected by the first vehicle C1 can be received by the second vehicle C2 running in the reverse direction, and the second vehicle C2 broadcasts the received event information under predetermined criteria while running in the reverse direction to the heading direction of the first and third vehicles C1 and C3. The event information broadcasted from the second vehicle C2 can be transferred to the third vehicle C3 when the second vehicle C2 enters into an area allowing broadcasting the event information as the second vehicle C2 runs in the reverse direction to the heading direction of the third vehicle C3.

In this way, event information can be transferred to vehicles that are out of coverage area of the first vehicle C1 through vehicles that run in the reverse direction to the heading direction of the first vehicle C1.

The traffic-interfering event may include at least one of events including a sudden stop, a sudden turn, a sudden lane change, a slide, a rollover, a collision, airbag inflation, honking the horn, etc., which may interfere with traffic. In operation S20, the event information may include the kind of event detected in operation S10, the time at which an event has occurred, the location at which the event has occurred, the time at which the first vehicle C1 has broadcasted the event information, or the heading direction of the first vehicle C1.

The event information broadcasted from the first vehicle C1 may be received by vehicles that enter the coverage area of the broadcasted signal. When both the second and third vehicles C2 and C3 enter the coverage area, the communication units of the second and third vehicles C2 and C3 can receive the event information.

Also, it is possible to terminate re-transmission and output of event information according to predetermined criteria. For example, when a predetermined time period has elapsed from the time an event occurred or from the time at which the second or third vehicle C2 or C3 has received event information, or when the second or third vehicle C2 or C3 has passed a predetermined distance from the location of an occurred event, transmission or output of the event information may be terminated.

According to this disclosure as described above, by causing, when a vehicle detects a traffic-interfering event in a lane in which the vehicle runs, the vehicle to broadcast event information to vehicles running in the reverse direction to the heading direction of the lane as well as to the following vehicles running in the same lane, and by causing the vehicles that have received the event information to broadcast the received event information, it is possible to effectively transfer event information to vehicles that are out of the coverage area of the vehicle that has detected the event while outputting no event information to the vehicles running in the reverse direction.

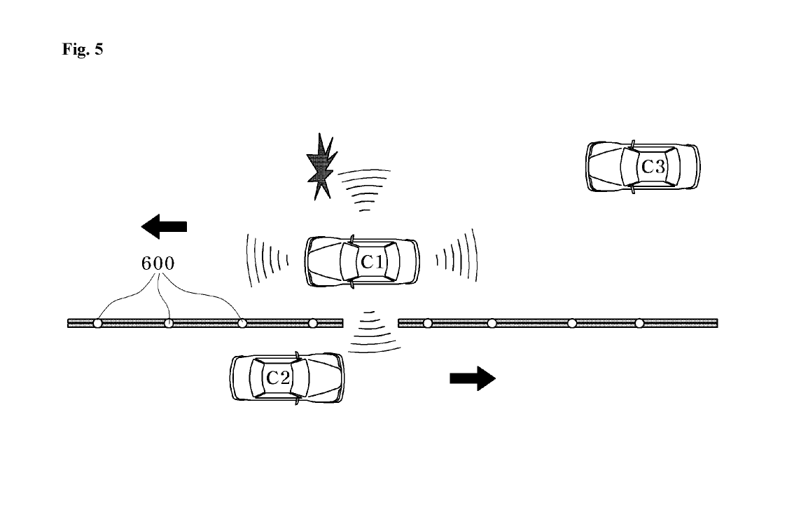

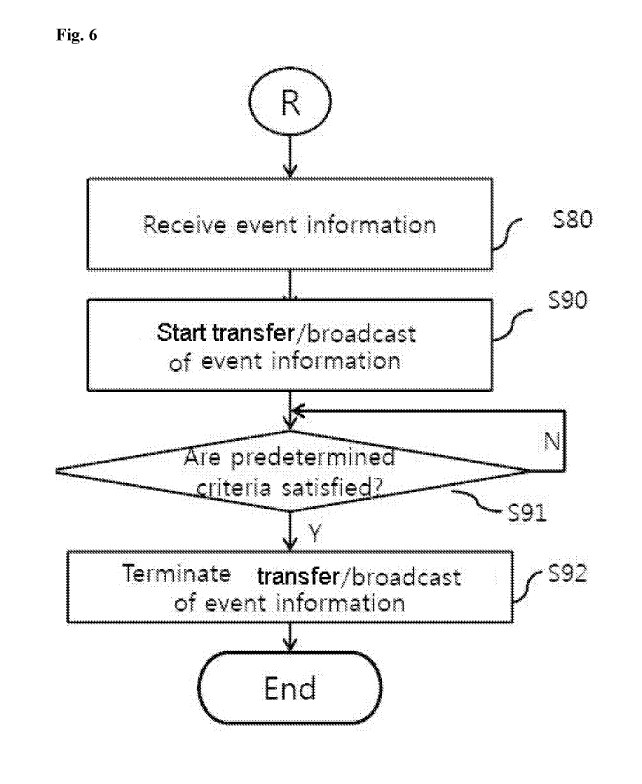

Hereinafter, another embodiment of a method of providing vehicles with information about a traffic-interfering event occurred on a road will be described with reference to FIGS. 5 and 6.

FIG. 5 shows an example where first, second, and third vehicles C1, C2, and C3 run on a road on which a plurality of relays 600 are arranged. In the example of FIG. 5, the first and third vehicle C1 and C3 run in a first direction, and the second vehicle C2 runs in a second direction. In detail, FIG. 5 shows a situation where a traffic-interfering event occurs when the first and third vehicles C1 and C3 run in a first direction in the same lane, and the first vehicle C1 suddenly changes lanes to the left lane, while the second vehicle C2 running in the second direction passes through an area in which the event has occurred.

In the example of FIG. 5, the relays 600 are arranged at regular intervals along a center lane. The relays 600 may be arranged at other appropriate locations, such as one shoulder or both shoulders, other than the center lane. The relays 600 may be electrically connected to each other for communication, wired or wirelessly. Each relay may receive event information, and transfer the event information to neighboring relays, or broadcast the event information. The communication method of the relays 600 may be the same as the communication method of the communication unit 300 as described above, and accordingly, a detailed description therefor will be omitted. FIG. 5 shows the case where the relays 600 are arranged at regular intervals along the center lane, however, it is also possible that a predetermined number of relays are arranged only in regions where the risk of accidents is high, such as regions with high frequency of accidents, regions with high frequency of fog, or roads with slide areas.

FIG. 6 is a flowchart illustrating a method of providing vehicles with event information through the relays 600 shown in FIG. 5. Referring to FIGS. 5 and 6, each relay 600 may receive event information broadcasted from the first, second, and third vehicles C1, C2, and C3 in a coverage area (S80), and transfer the received event information to neighboring relays while broadcasting the event information (S90). The transferring and broadcasting of the event information may be terminated according to predetermined criteria (S91 and S92). The predetermined criteria may be when a predetermined time period has elapsed from the time at which an event has occurred or from the time at which the event information has been received. The predetermined time period may be selected as a time period between one minute and several hours according to the kind or location of the event, accident statistics, etc. For example, when 5, 10, or 15 minutes have elapsed after an event has occurred, re-transmission of event information may be terminated. Also, the predetermined criteria may be when relays to which the event information is to be broadcasted are a predetermined distance away from the location of an occurred event or from the location at which the event information has been received. The predetermined distance may be set as a distance between 1 km and several dozens of km according to the kind, location, or time the event occurred, accident statistics, etc. For example, when relays that are distant by 1 km, 5 km, or 10 km from the location of an event that occurred, re-transmission of the event information can be terminated.

That is, according to the current embodiment, if at least one of a plurality of relays arranged along a road receives event information, the event information can be transferred to relays that are distant by a predetermined distance from the relay that has received the event information via one or more relays among the plurality of relays, and each relay that has received the event information broadcasts the event information so that vehicles entering the coverage area can receive the event information.

According to the current embodiment, it is possible to transfer information about a traffic-interfering event to vehicles through relays during hours in which vehicle traffic is low, such as dawn or at night.

Also, according to the present disclosure, a driver can receive various kinds of information without limitation on direction or distance even in weather conditions that modify the background that can affect driving. Since vehicles exchange their driving information with other vehicles to notify of any dangerous situations, multi-collision accidents can be prevented. Also, when a traffic pattern changes, the related information is transferred to vehicles through V2V communication so that drivers can promptly cope with the change in traffic pattern. In addition, by supporting a driver's precognition about an accident, accidents themselves can be prevented.

The system for providing vehicles with information about an event occurred on a road, according to the present disclosure, may be installed in an event data recorder of a vehicle, a navigation system, or a camera, and the method for providing vehicles with information about an event occurred on a road, according to the present disclosure, may be performed by the event data recorder of the vehicle, the navigation system, or the camera.

The foregoing is illustrative of the present disclosure and is not to be construed as limiting thereof. Although numerous embodiments of the present disclosure have been described, those skilled in the art will readily appreciate that many modifications are possible without materially departing from the novel teachings and advantages of the present disclosure. Accordingly, all such modifications are intended to be included within the scope of the present disclosure as defined in the claims. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

1. A method of providing vehicles with information about an event occurred on a road, comprising:
at a first vehicle running in a first direction on the road, detecting a traffic-interfering event; and
at the first vehicle, broadcasting event information including the location at which the event has occurred, or the heading direction of the first vehicle,
wherein the broadcasted event information is received by a second vehicle running in a second direction that is a different direction from the first direction on the road, and broadcasted by the second vehicle.

2. The method of claim 1, wherein the different direction is a reverse direction of the first direction.

3. A method of providing vehicles with information about an event occurred on a road, comprising:
at a second vehicle running in a second direction on the road, receiving event information including the location at which a traffic-interfering event has occurred, or the heading direction of a first vehicle, from the first vehicle running in a first direction that is a different direction from the second direction on the road; and
at the second vehicle, broadcasting the received event information during a predetermined time period or during a time period for which the second vehicle runs a predetermined distance.

4. The method of claim 3, wherein the broadcasted event information is received by a third vehicle running in the first direction, and provided as a warning to a driver of the third vehicle.

5. The method of claim 3, wherein the event information further includes the time at which the event occurred, or the kind of event.

6. The method of claim 3, wherein the second vehicle provides no warning to the driver of the second vehicle.

7. The method of claim 3, further comprising, at the second vehicle, stopping broadcasting the received event information according to predetermined criteria.

8. The method of claim 7, where the predetermined criteria is the time at which an event has occurred, the time at which the first vehicle has broadcasted the event information, or whether or not a predetermined time period has elapsed from the time at which the second vehicle has received the event information.

9. The method of claim 7, wherein the predetermined criteria is the location at which an event has occurred, the location at which the first vehicle has broadcasted the event information, or whether or not the second vehicle has passed a predetermined distance from the location at which the second vehicle has received the event information.

10. The method of claim 4, wherein the received event information by a third vehicle is broadcasted at the third vehicle during a predetermined time period or during a time period.

11. A method of providing vehicles with information about an event occurred on a road, comprising:
at a plurality of relays arranged along the road, receiving event information including the location at which a traffic-interfering event has occurred, or the heading direction of a first vehicle from the first vehicle running in a first direction on the road; and
at the plurality of relays, broadcasting the received event information,
wherein the broadcasted event information is received by a second vehicle running in a second direction that is a different direction from the first direction on the road along which the plurality of relays are arranged, and the event information is broadcasted during a predetermined time period or during a time period for which the second vehicle runs a predetermined distance.

12. The method of claim 11, wherein the broadcasted event information at the relay or the second vehicle is received by a third vehicle running in the first direction, and provided as a warning to the driver of the third vehicle.

13. The method of claim 11, wherein the received event information by a second vehicle is not provided as a warning to the driver of the second vehicle.

14-18. (canceled)
